(19) United States
(12) Patent Application Publication
(10) Pub. No.: US 2023/0004763 A1
(43) Pub. Date: Jan. 5, 2023

(54) RADIO FREQUENCY ENVIRONMENT AWARENESS WITH EXPLAINABLE RESULTS

(71) Applicant: BAE SYSTEMS Information and Electronic Systems Integration Inc., Nashua, NH (US)

(72) Inventors: James M. Stankowicz, JR., Boston, MA (US); Joseph M. Carmack, Milford, NH (US); Scott A Kuzdeba, Hollis, NH (US); Steven Schmidt, Charleston, SC (US)

(73) Assignee: BAE SYSTEMS Information and Electronic Systems Integration Inc., Nashua, NH (US)

(21) Appl. No.: 17/503,205

(22) Filed: Oct. 15, 2021

Related U.S. Application Data
(60) Provisional application No. 63/217,945, filed on Jul. 2, 2021.

(51) Int. Cl. G06K 9/62; G06K 9/00

(52) U.S. Cl. CPC G06K 9/6282; G06K 9/629; G06K 9/6232; G06K 9/6256; G06K 9/0055

(57) ABSTRACT

A Deep-Learning (DL) explainable AI system for Radio Frequency (RF) machine learning applications with expert driven neural explainability of input signals combines three algorithms (A1, A2, and A3). A1 is a neural network that learns to classify spectrograms. During training, A1 learns to map a spectrogram to its paired label. It outputs a label estimate from a spectrogram. Labels account for device number and spectrum utilization. The neural network is built on two-dimensional dilated causal convolutions to account for frequency and time dimensions of spectrogram data. A2 is a user-defined function that converts an input spectrogram into a vector that quantifies human-identifiable elements of the spectrogram. A3 is a random forest feature extraction algorithm. It takes as input the outputs of A2 and A1. From these, A3 learns which elements in the vector output by A2 were most important for choosing the labels output from A1.

### RELATED APPLICATIONS

This application claims the benefit of U.S. Provisional Applications No. 63/217,945, filed Jul. 2, 2021, which is herein incorporated by reference in its entirety for all purposes.

### FIELD

The following disclosure relates generally to signal processing and, more particularly, to a machine learning system to assess spectrum awareness and present results that are interpretable to humans.

### BACKGROUND

There is currently a lack of solutions for gaining the ability to autonomously detect and understand contextual shifts in the RF environment. Contextual shifts are the top level changes in spectrum use that dictate how individual devices are operating as a collective ensemble at any given moment, either by design or happenstance. Understanding this context is important for real-time situational awareness on the past and current RF environment for determining how to monitor and access the environment. Understanding this well leads to making more accurate predictions about the current and future RF environment, and increasing the performance and security of systems. With increasing demand for situational awareness for autonomous reasoning systems, some progress has been made to enhance system security through deep learning based RF fingerprinting and RF classification. However, in many operational systems, strong machine learned classification is simply not enough. In failure modes, human operators working alongside autonomous systems need direction as to what went wrong, or quick machine intuition into why a particular decision or classification was made. Deep learning based approaches may have been opening up new applications and increased performance in the RF domain, but they suffer a lack of insight into how decisions are made and where errors and mis-classifications may arise. This has largely left these approaches in the lab, as end users and operators have not fully embraced them due to lack of understanding.

As RF environments become increasingly congested, complex, and adaptive it is increasingly challenging for even expertly-tuned algorithms to manage and interpret the spectrum, let alone in a way that makes sense to an operator or analyst. Machine learning algorithms are candidates for tackling spectrum sensing without reliance on expertly-tuned algorithms, but often work like “black boxes”, supplying no insight into what the algorithm learned.

What is needed is a system and method to turn the output of such a “black box” machine learning algorithm into something human interpretable via a user-defined dictionary for multiple machine learning applications.

### SUMMARY

An embodiment provides a Deep-Learning (DL) explainable AI system for scene context change detection and classification with expert driven neural explainability of input signals comprising a Classification Module (CM) comprising Dilated Causal Convolutions (DCC) layers, whereby a number of devices and spectrum density are measured into bins, producing a set of classes describing these salient features of the spectrum environment; and an Explainability Module (EM) comprising a series of Random Forests classifiers and a genetic algorithm optimization, whereby a subset of most important expert features for each class from the CM are identified; and outputting a condensed set of salient expert features for a given EM prediction as human readable sentences; wherein the CM comprises: a rectified linear unit (ReLU) and batch normalization layer whereby features from the DCC are combined; convolution and pooling layers whereby feature size is reduced; and softmax classification layer whereby output is provided; wherein the CM DCCs perform convolutions in frequency and dilated convolutions in time; and whereby an output is human interpretable. In embodiments the input signals are digital Radio Frequency (RF) Wi-Fi 802.11a/g waveforms. In other embodiments, the spectrogram for each sample scene class were 5 MHz wide and 1 ms in duration, with bin spacing to form a 128×38×2 (2=phase and magnitude) sized image (nfft=128, noverlap=128, window=256). In subsequent embodiments spectrograms comprise two channels in the third dimension where phase and magnitude representation to maintain the complex-valued nature of the underlying data (vs IQ data) and the training dataset was constructed with 1,000 examples per class. For additional embodiments classes comprise two primary traffic parameters, the number of devices in the scene and their spectrum usage, i.e., spectral density. In another embodiment, the number of devices comprise 3 sub-classes, low, medium, and high. For a following embodiment spectral density comprises 3 sub-classes, low, medium, and high. In subsequent embodiments expert feature generation provides a set of human interpretable features that an expert who is monitoring the spectrum would understand and use to describe the scene. In additional embodiments expert features comprise time, frequency, and power.

Another embodiment provides an EM feature vector where the salient expert features are defined as (1) Brightness”, of received power normalized between 0 and 1; (2) “Time-half” determines the amount of activity in the early and later parts of the monitored period, i.e., the first or second half, enumerated 1 or 2; (3) “Energy in segment x” is the sum of all values in segment x and is min-maxed normalized; (4) “Time-energy product in segment x” is a count of the time bins in segment x for which any pixels exceed half the max value in the segment; and (5) “Consistent energy from segment x to y” is a Boolean set to true if both halves of the time period have relatively equal amounts of energy, i.e., activity surrogate.

In yet further embodiments Brightness, segment energy, and time-energy product each comprises 8 features, 1 for each segment, consistent energy produces 4 features for the channelized transients between the time segments and time-half produces 2 features, one for each half, all of these features are encoded into the feature vector of size 30. In related embodiments comprising two correlated datasets, one of raw spectrograms for classification by the deep learning-based CM, and the second which is a simplified human annotated dictionary for classification by the EM. For further embodiments the DCC comprises a 3-dimensional DCC operator whereby a tight coupling of phase and magnitude is maintained throughout feature extraction of a network. In ensuing embodiments EM comprises a down-selection of features most relevant for each classification label, wherein classes are processed one class at a time in a one-versus-all fashion. For yet further embodiments, each sentence s can be thought of as a polytope edge in the full feature space which defines the activation of the class label.

An embodiment provides a Deep-Learning (DL) explainable AI system for Radio Frequency (RF) machine learning applications with expert driven neural explainability of input signals comprising a Classifier Module; an Explainability Module; an Important Features module; a Training Phase; and an Inference Phase; the Training Phase comprising a first training input comprising a Ground Truth Training Input and a second training input comprising a Raw RF Features Training Input; the Inference Phase comprising input of Raw RF Features input signals; and an output of Ground Truth comprising Feature Annotation, whereby the explainability is provided. In embodiments the Training Phase comprises an Error Between Ground Truth and Class Prediction Module receiving the first training input of a Class Ground Truth Target; an RF Classifier Module (RCM) RCM Training Update Module receiving input from the Error Between Ground Truth and Class Prediction Module; an RF Classifier Module (RCM) receiving input from the RCM Training Update Module; a Class Prediction Module receiving input from the RCM; an Error Between RCM Prediction and Explainability Module (EM) Prediction Module receiving a first input, from the Class Prediction Module; an EM Training Update Module receiving input from the Error Between RCM Prediction and EM Prediction Module; an Explainability Module (EM) receiving input from the EM Training Update Module; a Class Prediction with EM Annotations Module receiving input from the EM, the Class Prediction with EM Annotations Module providing a second input to the Error Between RCM Prediction and EM Prediction Module; a Genetic Algorithm Discovery of K-most Important Class Features Module also receiving input from the EM; the second training input Raw RF Features Training Input providing input to the RCM; a Raw-to-Expert Feature Mapping Module also receiving input from the Raw RF Features training input; an Expert RF Features Module receiving input from the Raw-to-Expert Feature Mapping Module, and providing a second input to the EM; and a Genetic Algorithm Discovery of K-most Important Class Features Module receiving an input from the Expert RF Features Module, and receiving a second input from the EM, thereby producing a trained system. In other embodiments, the Inference Phase comprises a trained Classifier Module receiving the Raw RF Features input signals; a Raw-to-Expert Feature Mapping Module also receiving the Raw RF Features input signals; an Expert RF Features Module receiving input from the Raw-to-Expert Feature Mapping Module; a trained Explainability Module receiving input from the Expert RF Features Module; and outputting a Class Prediction with K-most Important Expert Feature Annotations for the Raw RF Features input signals, whereby the input signal classification with explainability is provided. In subsequent embodiments the Radio Frequency (RF) machine learning applications comprise scene context change detection and classification; and input signals are digital Radio Frequency (RF) Wi-Fi 802.11a/g waveforms. For additional embodiments classes comprise two primary traffic parameters, a number of devices in a scene and their spectrum usage or spectral density. In another embodiment a number of devices comprise 3 sub-classes, low, medium, and high. For a following embodiment spectral density comprises 3 sub-classes, low, medium, and high. In subsequent embodiments expert feature generation provides a set of human interpretable features that an expert who is monitoring the spectrum would understand and use to describe the scene. In additional embodiments expert features comprise time, frequency, and power. In included embodiments an EM feature vector comprises a Brightness of received power normalized between 0 and 1; a Time-half determining an amount of activity in early and later parts of a monitored period, enumerated as 1 or 2; an Energy in segment as a sum of all values in segment x, min-maxed normalized; a Time-energy product in segment x count of time bins in segment x for which any pixels exceed half a max value in the segment x; and a Consistent energy from segment x to y Boolean, set to true if both halves of a time period have relatively equal amounts of energy. In yet further embodiments the Brightness, the Segment energy, and the Time-energy product each comprises 8 features, 1 for each segment, the Consistent energy produces 4 features for channelized transients between time segments, and the Time-half produces 2 features, one for each half, wherein all features are encoded into the feature vector, of size 30. In related embodiments comprising two correlated datasets, one of raw spectrograms for classification by the deep learning-based CM, and a second which is a simplified human annotated dictionary for classification by the EM. For further embodiments the DCC comprises a 3-dimensional DCC operator whereby a tight coupling of phase and magnitude is maintained throughout feature extraction of a network. In ensuing embodiments the EM comprises a down-selection of features most relevant for each classification label, wherein classes are processed one class at a time in a one-versus-all fashion. For yet further embodiments, each sentence s can be thought of as a polytope edge in a full feature space which defines an activation of a class label.

Another embodiment provides a non-transient computer readable medium containing program instructions for causing a computer to perform the method of inputting a first training input comprising a Ground Truth Training Input in a Training Phase; and inputting a second training input comprising a Raw RF Features Training Input in the Training Phase; training a Classifier Module in the Training Phase; training an Explainability Module in the Training Phase; training an Important Features module in the Training Phase; inputting Raw RF Features input signals in an Inference Phase; and outputting Ground Truth comprising Feature Annotation, whereby explainability is provided. For more embodiments input comprises a spectrogram for each sample scene class being 5 MHz wide and 1 ms in duration. Continued embodiments include input comprising a spectrogram for each sample scene class with bin spacing forming a 128×38×2 sized image comprising phase and magnitude, where nfft=128, noverlap=128, and window=256. For additional embodiments, input comprises spectrograms comprising two channels in a third dimension where phase and magnitude representation maintain a complex-valued nature of underlying data, and a training dataset is constructed with 1,000 examples per class.

A yet further embodiment provides a Deep-Learning (DL) explainable AI method for scene context change detection and classification with expert driven neural explainability of input signals comprising a Training Phase; and an Inference Phase; the Training Phase comprising an Error Between Ground Truth and Class Prediction Module receiving the first training input of a Class Ground Truth Target; an RCM Training Update Module receiving input from the Error Between Ground Truth and Class Prediction Module; an RF Classifier Module (RCM) receiving input from the RCM Training Update Module; a Class Prediction Module receiving input from the RCM; an Error Between RCM Prediction and Explainability Module (EM) Prediction Module receiving a first input, from the Class Prediction Module; an EM Training Update Module receiving input from the Error Between RCM Prediction and EM Prediction Module; an Explainability Module (EM) receiving input from the EM Training Update Module; a Class Prediction with EM Annotations Module receiving input from the EM, the Class Prediction with EM Annotations Module providing a second input to the Error Between RCM Prediction and EM Prediction Module; a Genetic Algorithm Discovery of K-most Important Class Features Module also receiving input from the EM; the second training input Raw RF Features Training Input providing input to the RCM; a Raw-to-Expert Feature Mapping Module also receiving input from the Raw RF Features training input; an Expert RF Features Module receiving input from the Raw-to-Expert Feature Mapping Module, and providing a second input to the EM; and a Genetic Algorithm Discovery of K-most Important Class Features Module receiving an input from the Expert RF Features Module, and receiving a second input from the EM, thereby producing a trained system; wherein the Inference Phase comprises a trained RF Classifier Module receiving the Raw RF Features input signals; a trained Raw-to-Expert Feature Mapping Module also receiving the Raw RF Features input signals; a trained Expert RF Features Module receiving input from the Raw-to-Expert Feature Mapping Module; a trained Explainability Module receiving input from the Expert RF Features Module; and outputting a Class Prediction with K-most Important Expert Feature Annotations for the Raw RF Features input signals, whereby the input signal classification with explainability is provided.

### BRIEF DESCRIPTION OF THE DRAWINGS

FIG. 1 depicts a High-Level System Overview configured in accordance with an embodiment.

FIG. 2 depicts a General System Architecture configured in accordance with an embodiment.

FIG. 3 depicts a classifier module configured in accordance with an embodiment.

FIG. 4 depicts an explainability module (EM) configured in accordance with an embodiment.

FIG. 5 depicts feeding DCC embedding layers to an explainability module configured in accordance with an embodiment.

FIG. 6 depicts DCC AND EM diagrams configured in accordance with an embodiment.

FIG. 7 depicts nine RF scene classes configured in accordance with an embodiment.

FIG. 8 depicts an expert encoded feature breakdown configured in accordance with an embodiment.

FIG. 9 depicts performance/accuracy configured in accordance with an embodiment.

FIG. 10 depicts an RF environment with labeled segments for high device number, medium intensity configured in accordance with an embodiment.

FIG. 11 depicts an RF environment with labeled segments for medium device number, low intensity configured in accordance with an embodiment.

FIG. 12 depicts a Training Phase method flowchart configured in accordance with an embodiment.

FIG. 13 depicts an Inference Phase method flowchart configured in accordance with an embodiment.

These and other features of the present embodiments will be understood better by reading the following detailed description, taken together with the figures herein described. The accompanying drawings are not intended to be drawn to scale. For purposes of clarity, not every component may be labeled in every drawing.

### DETAILED DESCRIPTION

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes, and not to limit in any way the scope of the inventive subject matter. The invention is susceptible of many embodiments. What follows is illustrative, but not exhaustive, of the scope of the invention.

Previous work is described in U.S. patent application Ser. No. 17/142,800 “ARTIFICIAL INTELLIGENCE RADIO CLASSIFIER AND IDENTIFIER”; U.S. patent application Ser. No. 16/539,578 “RF FINGERPRINT ENHANCEMENT BY MANIPULATION OF AN ABSTRACTED DIGITAL SIGNAL” filed Aug. 13, 2019; and U.S. patent application Ser. No. 17/358,153 “NOVEL METHOD FOR SIGNAL REPRESENTATION AND CONSTRUCTION” filed Jun. 25, 2021 are incorporated, by reference, in its entirety, for all purposes.

In embodiments, a machine learning algorithm is trained to assess spectrum awareness. In particular, it identified the number of devices present and spectrum utilization of wireless RF environments from spectrogram data in a way that is interpretable to humans in a way that makes sense to an operator or analyst.

Embodiments combine three algorithms. Algorithm 1 (A1) is a neural network that learns to classify spectrograms. During training, A1 learns to map a spectrogram to its paired label. After training, A1 takes a spectrogram as input, and estimates a label as output. For our example use case, the labels accounted for the number of devices and utilization of the spectrum, though it is straightforward to pivot to different use cases. Embodiment neural network used for A1 is specifically tailored to RF-domain data, in itself a novel contribution to the field. This neural network is built on two-dimensional dilated causal convolutions to account for the frequency and time dimensions of spectrogram data. These convolutions are well suited for processing spectrogram data. Algorithm 2 (A2) is a user-defined function that takes a spectrogram as input, and converts it into a vector that quantifies human-identifiable elements of the spectrogram. Examples of entries to this vector are: “brightness” of the pixels in various frequency and time bins of the spectrogram (to capture power or phase), or the number of bright bands in the spectrogram (which is something a human operator might use to estimate number of devices). Embodiments generalize these features, and in a general-use setting A2 allows subject matter experts to define the “vocabulary” that machine learning algorithms use. This novel contribution directly ties together current approaches of operator or analyst defined tasking with the flexibility and learnability of deep learning. Algorithm 3 (A3) is a random forest feature extraction algorithm. It takes as input the output of A2 and the output of A1. From these two inputs, A3 learns which elements in the vector output by A2 were most important for choosing the labels output from A1.

Embodiments allow analysts, operators, or general users (i.e., design engineer, reprogrammer, etc.) to understand the “thinking” of a machine learning algorithm that has been trained to understand spectrogram utilization. Of the three algorithms constituting embodiments (A1, A2, A3), A1 is similar to the “black box” approach, with the innovation that it is specifically designed to operate well on RF spectrogram data. This is distinct from an expert-defined algorithm because A1 is capable of generalizing to novel scenarios like new transmitters or physical surrounding. The point of A2 in embodiments is to allow the user to define a “vocabulary” for the machine learning algorithm. Then A3 serves as a translator that converts the output of A1 into the vocabulary defined by the user in A2. Analogs to A2 and A3 have not been applied to RF problems before. Another advantage to the solution is that it is immediately applicable to any machine learning process that performs classification, and is likely applicable with minor adaptation to machine learning tasks that output something other than classification labels.

There are numerous applications of applying embodiments to radio frequency domain tasks, stemming from the several novel components. The neural network based spectrum awareness part of the system has applicability to applications and problems that have a spectrogram or similar input to them, i.e., a temporal ordering and some second feature (frequency) forming a causal 2D image. Embodiments may extend into cyclostationary features or other types of features captured in a CAF process. The explainability part of this system is more wide ranging and a critical piece that is needed for RF systems as more solutions turn to deep learning approaches. Having explainability in terms that analysts and operators use will be critical for operational use.

Embodiments provide a framework to perform radio frequency (RF) scene context change detection and classification with Expert driven neural explainability. Embodiments use a deep learning based classifier to perform spectrum monitoring of Wi-Fi devices and usage patterns with an auxiliary classifier operating post-hoc to output human interpretable reasoning for classification declarations. Classification network embodiments operate on input spectrograms through a series of dilated causal convolution layers for feature extraction which are fed into classification layers. Dilated causal convolutions (DCC) are well suited for RF applications, including RF fingerprinting, their use is extended here to new applications. The Explainability Module operates over an auxiliary dataset that is built based on domain expertise for learning how to reason over the classification network outputs. These two approaches, the deep learning classifier and Explainability Module are combined into a unique explainable deep learning approach that is applied to Wi-Fi spectrum monitoring. This fused approach leverages the power of deep learning classification with user interpretable explainability.

The emerging field of Explainable Artificial Intelligence (XAI) has risen to address deficiencies and provide the insight that human operators require to work hand-in-hand and trust the AI systems. Explainable deep learning approaches include post-hoc interpretability where explanations are extracted from the model. Embodiments apply post-hoc interpretability to a black box neural network. Embodiments provide methods that, after the main AI classifier makes a declaration, provide intuition on why the decision was made post-hoc in a way that can be understood by the human operator. These methods extract expert operator relevant outputs, enabling split-second decisions to be made without needing extensive training to be an expert in explainable AI methods. Embodiments combine three novel contributions in the RF XAI System: (1) Wi-Fi spectrum monitoring datasets with a programmatically scripted dictionary of expert terms and features, (2) deep learning-based spectrum monitor Classification Module (CM), and (3) Explainability Module (EM) for extraction of important features from the expert annotations. These embodiments insert the interpretability directly into the network to force the network to inherently learn mappings to a provided interpretable feature set through the use of concept bottlenecks in a post-hoc manner.

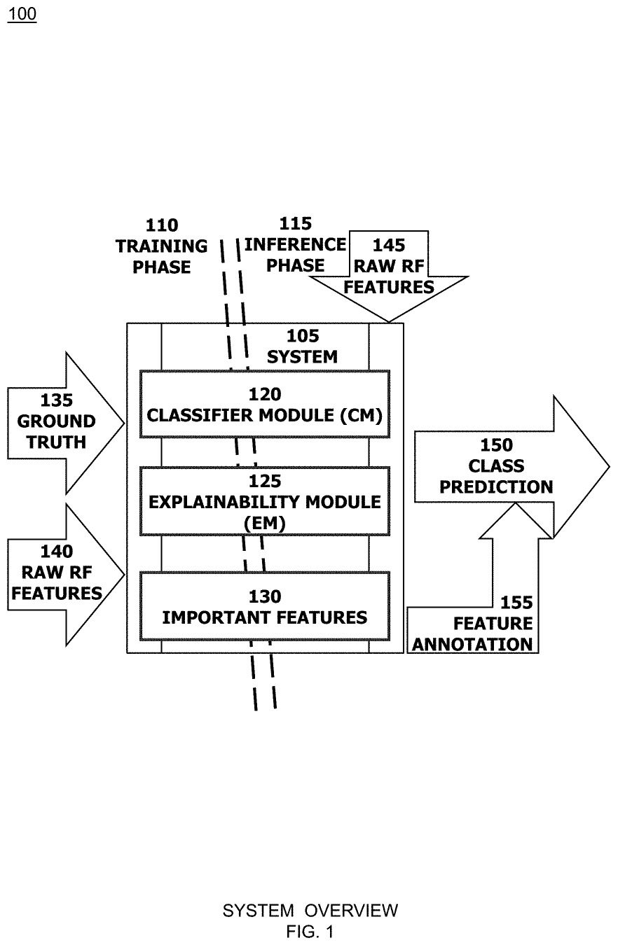

FIG. 1 depicts a High-Level System Overview 100. Embodiments of System 105 comprise a Training Phase 110 and an Inference Phase 115. Modules trained in the system comprise Classifier Module (CM) 120, Explainability Module (EM) 125, and Important Feature module 130. Inputs to Training Phase 110 comprise Ground Truth 135 and Raw RF Features 140. Inference Phase 115 follows Training Phase 110. Input during Inference Phase 115 comprises Raw RF Features 145. Output of Inference Phase 115 comprises Class Prediction 150 to which Feature Annotations 155 are applied. Details of each component, including interactions, follow.

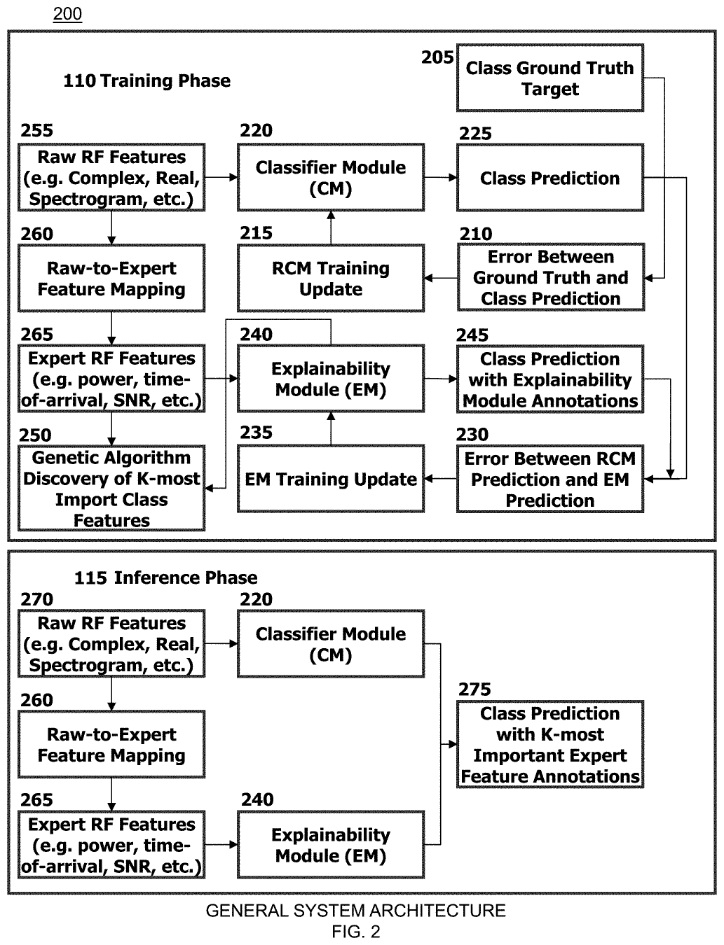

FIG. 2 depicts a General System Architecture 200. As depicted in FIG. 1, embodiments of the General System Architecture comprise a Training Phase 110 and an Inference Phase 115. In Training Phase 110, the system is trained to perform explainable classification. In Inference Phase 115, the system has been trained already, and is being queried for class predictions with expert annotations provided by the explainability module. Emphasizing just the processing flow, Training Phase 110 comprises training input of Class Ground Truth Target 205 which provides input to Error Between Ground Truth and Class Prediction 210. Output of Error Between Ground Truth And Class Prediction Module 210 provides input to RCM Training Update 215. RCM Training Update 215 output provides input to Classifier Module (CM) 220. Output of RCM 220 provides input to Class Prediction 225. Output of Class Prediction 225 provides a first input to Error Between RCM Prediction and Explainability Module (EM) Prediction 230. Output of Error Between RCM Prediction and EM Prediction 230 provides input to EM Training Update 235. Output of EM Training Update 235 provides input to Explainability Module (EM) 240. Output of EM 240 provides input to Class Prediction with Explainability EM Annotations 245 and Genetic Algorithm Discovery of K-most Important Class Features 250. Output of Error Between Ground Truth And Class Prediction 210 provides a second input to Error Between Ground Truth And Class Prediction 230. A second input to Training Phase 110 are Raw RF Features 255. Raw RF Features 255 provides input to both CM 220 and Raw-to-Expert Feature Mapping Module 260. Output of Raw-to-Expert Feature Mapping Module 260 provides input to Expert RF Features 265. Output of Expert RF Features 265 provides input to both EM 240 and to Genetic Algorithm Discovery of K-most Important Class Features 250.

Again emphasizing just the processing flow, in FIG. 2, Inference Phase 115 comprises input of Raw RF Features 270 to both (trained) RCM 220 and (trained) Raw-to-Expert Feature Mapping 260. Output of Raw-to-Expert Feature Mapping 260 provides input to (trained) Expert RF Features 265. Output of Expert RF Features 265 provides input to (trained) Explainability Module (EM) 240. Finally, output of both RCM 220 and EM 240 provide input to Class Prediction with K-most Important Expert Feature Annotations 265, which is the output of the system.

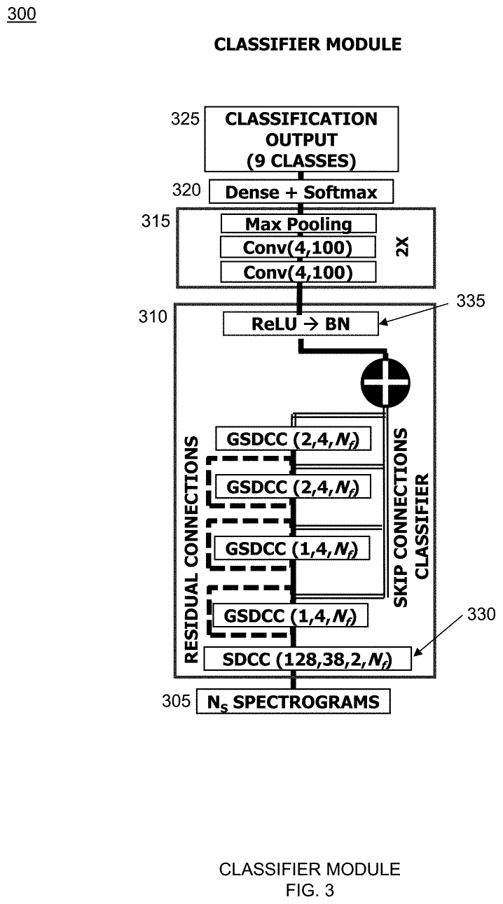

FIG. 3 depicts a RF Classifier Module (CM) 300. Components comprise Spectrograms input 305; Skip Connections Classifier 310; Convolution and Pooling Layers 315, Softmax Classification Layer 320; and Classification Output 325. For spectrum monitoring, the network input 305 is a complex-valued spectrogram, as opposed to complex-valued IQ data. Spectrogram inputs 305 are sized 128×38×2, with the last dimension representing the complex-valued nature of the spectrogram as phase and magnitude. Embodiments modify the DCC operation to perform traditional convolutions in frequency and dilated causal convolutions in time to exploit the causal nature of RF signals and to efficiently scale to RF data rates. To maintain the tight coupling of phase and magnitude throughout the feature extraction of the network, embodiments utilize a 3-dimensional DCC operator, where the feature maps of each layer are the same shape as the input, 128×38×2, 330. This enables maintaining the coupling of phase and magnitude in the learned feature representations. Following the DCC layers, a Rectified Linear Unit (ReLU) 335 and Batch Normalization (BN) layer are applied to combine the features from the various DCC layers 310, which employ skip connections. This is followed by traditional convolution and pooling layers 315 to reduce the feature size. Finally, a softmax classification layer 320 provides the output 325. The classifier is trained to output the number of devices and spectrum density, both measured into the coarse bins of high, medium, and low.

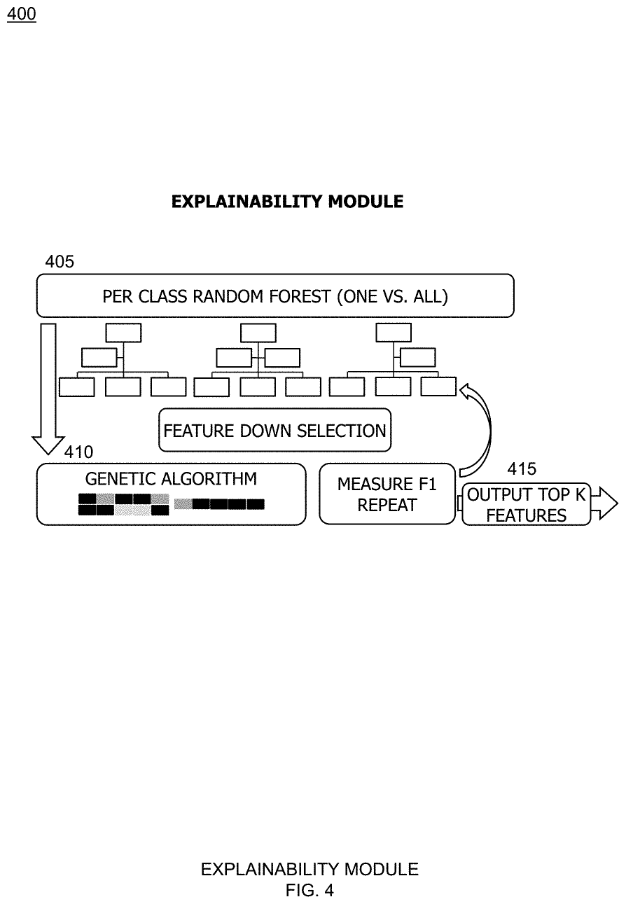

FIG. 4 depicts an Explainability Module (EM) 400. The EM is a two part ensemble of algorithms, the first being a series of Random Forests Classifiers 405 and the second a Genetic Algorithm optimization 410 to identify a subset of most important expert features for each class (RF scene). In embodiments, it is trained using the auxiliary dataset on both ground truth target labels and surrogate labels from the output of the CM. The classification accuracy on ground truth data is used to validate that the expert guided feature space has merit on ground truth, as embodiments are really interested in understanding the most important (K) features 415 in the RCM classification space. By this, it is meant that once it is established that the expert feature set has discriminative merit, only training on the surrogate labels produced by the RCM to provide insight into its classifications is considered.

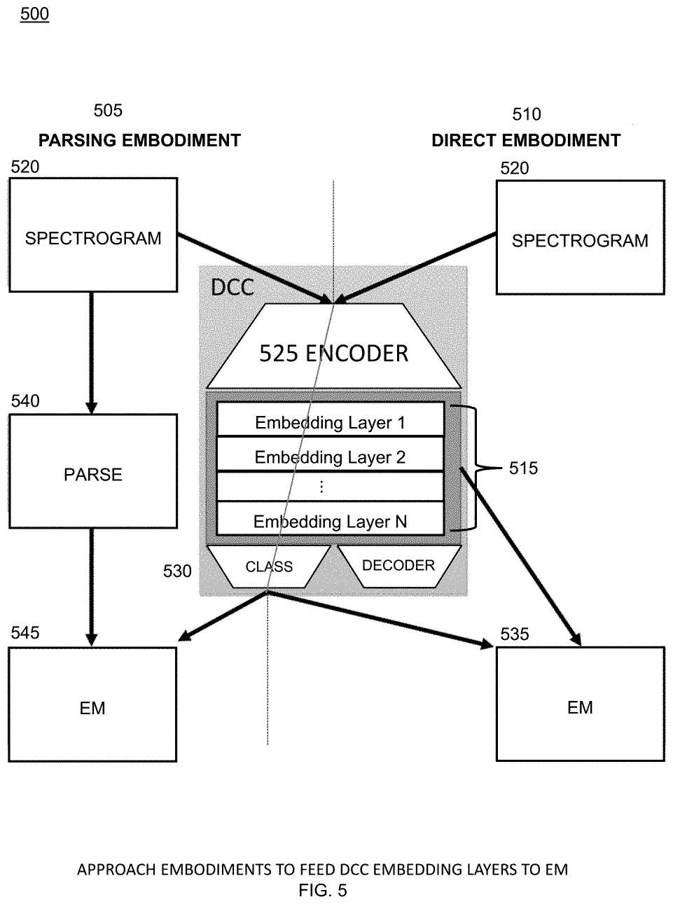

FIG. 5 depicts feeding DCC embedding layers to an Explainability Module 500. Embodiments comprise Parsing Embodiments 505 and Direct Embodiments 510. In embodiments, an architecture is designed similarly to an autoencoder. This network has “embedding layers” 515 that behave analogously to basis functions in a Fourier transform. Where a Fourier decomposition converts a signal into a basis of orthogonal, sinusoidally varying, functions using a Fourier transform, the DCC uses a data-driven approach to learn optimal basis functions and optimal transforms. Embodiments have extended this to arbitrary input shapes (namely to spectrograms 520 rather than IQ representations of signals), while preserving the fact that the embedding layers 515 match the original input shapes. Embodiments apply spectrograms 520 to encoder 525, then, via Embedding Layers 515, Class 530 is output to the EM 535. In embodiments, Embedding Layers 515 provide output directly to the EM 535, in other embodiments, the spectrogram is also parsed 540, providing input to the EM 545.

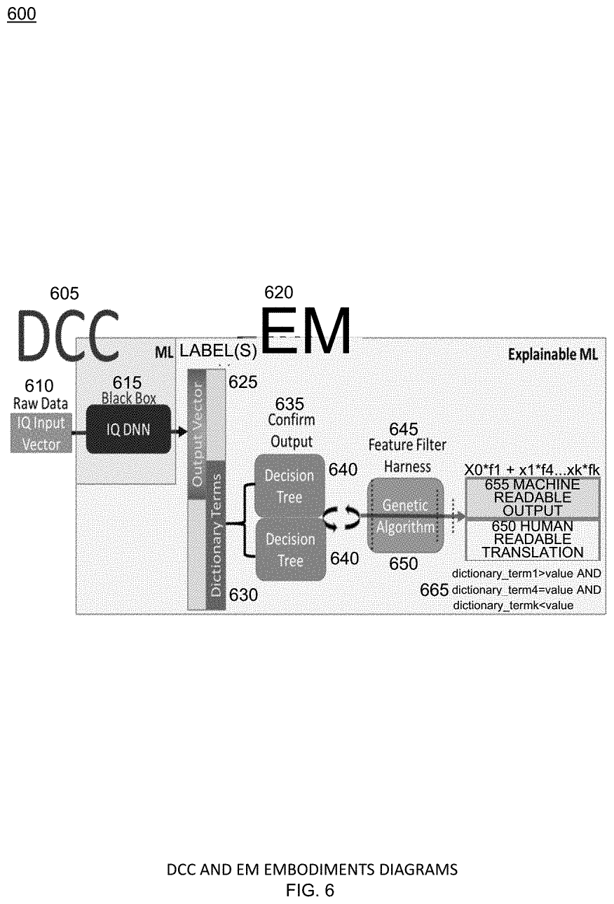

FIG. 6 depicts DCC AND EM diagrams 600. DCC 605 comprises raw data IQ input vector 610 to (black box) IQ DNN 615 with Machine Learning (ML). This then inputs to the EM 620 with Label(S) for Output Vector 625 and Dictionary Terms 630. Output is confirmed 635, including decision trees 640. These then interface with a Feature Filter Harness 645 comprising a genetic algorithm 650. This is then input for Machine Readable Output 655 having a Human Readable Translation 660. Examples comprise the form of: dictionary_term1>value AND dictionary_term4=value AND dictionary_termk<value 665, for explainable ML.

The spectrum monitoring dataset consists of spectrograms and the auxiliary dataset contains the dictionary of domain specific terminology. This auxiliary dataset provides high level features in terms of time, power, and frequency which a human operator might use to describe a changing RF landscape. Embodiments use a simple Wi-Fi simulation to create both datasets and test this step into RF XAI, and focus on a simple spectrum monitoring case of determining the number of users accessing the network and their aggregate spectral usage.

Embodiments use a Matlab simulation to create simple Wi-Fi traffic patterns and scenes to assess the spectrum monitoring XAI system. Embodiments leverage Matlab's WLAN toolbox to model Wi-Fi, 802.11ag, emissions and apply built-in simple channel models to generate receive representations. Embodiment simulations are within the ISM band, 2.4 GHz, with 1 MHz bandwidth signals sampled at 5 MSps. The simulation uniformly samples two primary traffic parameters, the number of devices in the scene and their spectrum usage, i.e., spectral density. The number of devices fell into 3 sub-classes: low to represent a single person with a few devices or a few people with one device each, medium to represent a small group of people, and high to represent a larger gathering. Similarly, the spectral density is uniformly sampled, again with 3 sub-classes: low to model sparse network access and primarily control flows, medium to represent asynchronous downloads/uploads, and high to represent sustained spectral usage, i.e., watching a movie. For embodiments, Low spectral density comprises primarily of beacons sent on the order of 200 μs, while medium and high density scenarios add in data packets, with high density devices having idle times on the order of 1 μs to model constant data packets such as video streaming.

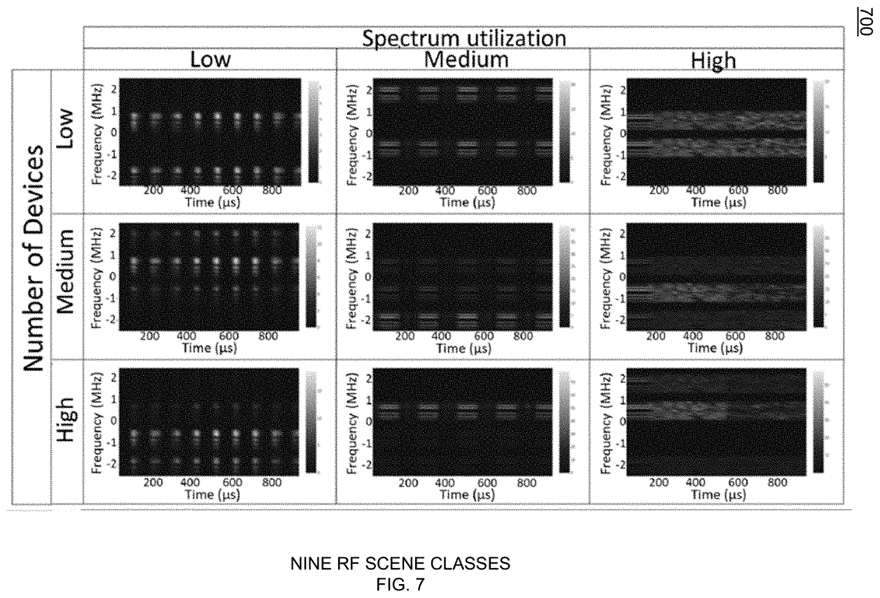

FIG. 7 presents nine RF scene classes 700, showing examples of simulated traffic patterns and scenes. Various channel models were randomly sampled using built-in Matlab functionality, including different variations of additive white Gaussian noise as well as indoor and outdoor channel models that model different levels of multi-path. Transmit power was set to model a smart phone operation, set at 24 dBm. Both stationary and mobile emitters were modeled at various locations creating various receive SNR levels. A good use case for these types of RF scenes can be a coffee shop that dynamically shifts throughout the day as users come and go and they shift between work, browsing, and connecting with others.

For each sample scene above, a spectrogram is extracted as an example of that class for the raw spectrogram input. The spectrograms were 5 MHz wide and 1 ms in duration, with bin spacing to form a 128×38×2 sized image (nfft=128, noverlap=128, window=256). The two channels in the third dimension where phase and magnitude representation to maintain the complex-valued nature of the underlying data. The training dataset was constructed with 1,000 examples per class.

The goal of Expert Feature Generation 265 is to provide a set of human interpretable features that an expert who is monitoring the spectrum would understand and use to describe the scene. In embodiments, the set of features fall along three dimensions that are typically used in RF scene understanding tasks: time, frequency, and power. Time features indicate if users or usage is dynamically stable or changing, with potential indication of contextual shifts. In this first test, spectrograms are split into two time segments to assess whether activity is consistent or changing.

Embodiments for time accounting build in a continuous and more distinct accounting of temporal recurrence to alleviate the current naïve temporal segmenting. Embodiments also segment along the frequency axis to channelize along Wi-Fi channelizations. Finally, power is leveraged as a surrogate for separating out users, i.e., those that are nearby to the receiver versus further away. In more generalizable applications, power helps provide insight into such things as whether a primary user or jammer is present, how much co-channel interference there is, etc.

Brightness, segment energy, and time-energy product each produced 8 features, 1 for each segment, while consistent energy produced 4 features for the channelized transients between the time segments and time-half produced 2 features, one for each half. Embodiments encode all of these features into a feature vector which is size 30. At this point, there are two correlated datasets, one of raw spectrograms for classification by the deep learning-based CM, and the second which is a simplified human annotated dictionary for classification by the EM.

For embodiments, RF scene understanding entails the process of separating the temporal evolution of a part of the electromagnetic spectrum into different classes that describe how the spectrum is being used, i.e., the overarching context of the spectrum at any given moment. RF scenes are dynamic and change as a function of time, user access, geo-political stances, etc., each at multiple resolutions. For embodiments, it is important to know these contextual changes and how the spectrum is currently being used for both receivers (i.e., SIGINT platforms, spectrum monitors, security nodes, etc.) and transmitters (i.e., secondary users in dynamic spectrum access (DSA) systems, cognitive radios, resource allocation, etc.). In embodiments, 9 different context classes of scene behavior are employed.

For initial testing, a use case of a Wi-Fi spectrum monitor is developed that is assessing the number of Wi-Fi emitters present and their spectral usage to make decisions. As mentioned, system embodiments consist of two main components: the spectrum monitor Classifier Module (CM) and the Explainability Module (EM). The Classifier operates on complex-valued spectrograms to capture both magnitude and phase and outputs classification on how many users are currently accessing their spectral density. The time and frequency extent of the spectrograms, along with the respective resolutions across these dimensions, is a function of the application and the granularity needed. Again as mentioned, in embodiments, a Wi-Fi monitoring system is tested, and hence sets the parameters of the system based on this application. Expert spectrogram features are also needed to train the EM. The classifier thus performs the spectral monitoring function to determine spectrum utilization with the EM providing post-hoc explanations of classification using most impactful expert terms.

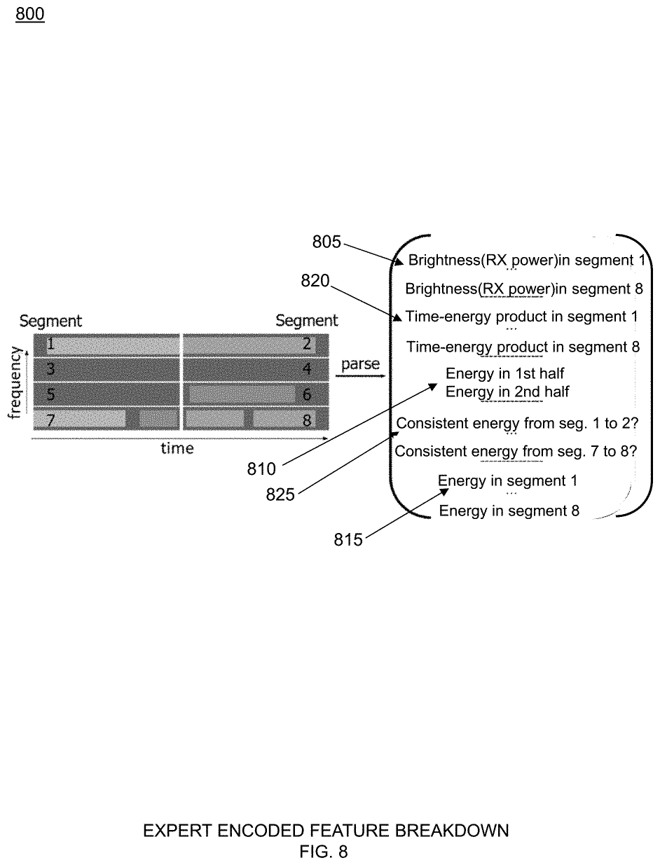

FIG. 8, an expert encoded feature breakdown 800, depicts examples of the above-mentioned segmentations. An embodiment feature vector for EM use is defined as: “Brightness” 805 of received power normalized between 0 and 1; “Time-half” 810 determines the amount of activity in the early and later parts of the monitored period, i.e., the first or second half, enumerated 1 or 2; “Energy in segment x” 815 is the sum of all values in segment x and is min-maxed normalized; “Time-energy product in segment x” 820 is a count of the time bins in segment x for which any pixels exceed half the max value in the segment; and “Consistent energy from segment x to y” 825 is a Boolean set to true if both halves of the time period have relatively equal amounts of energy, i.e., activity surrogate.

For embodiments, the EM operates on the expert feature space which is encoded into matrix form. Each data point, i.e., spectrogram, makes up the rows of the matrix while the columns are made up of the numerical encodings of the expert features. In embodiments we have x₁, . . . , xₙ, where n denotes the full set of features with n=30. The EM's first objective is to obtain a down-selection of features which are most relevant for each particular classification label. The algorithm processes one class at a time, in a one-versus-all fashion. As depicted in FIG. 4, the feature down select process starts by extracting a percentage subset of most important features. With the goal of explaining each class in k features or less, embodiments proceed with randomly extracting a further subset (population in the genetic algorithm), containing no more than k features but potentially less. A one vs. all Random Forests classifier, which is called the class model, is then trained using this expert feature subset, and the F1 score (Table 1) is computed with the additional cost function loss variable being the cardinality of k. The F1 score and cardinality loss are used as the health indicators in the genetic algorithm. At the end of the genetic algorithm optimization, the target class of interest's k-most important features are output as well as the one vs all class model. For RF scene classification problems, this results in 9 class models, one for each of the 9 classes.

In embodiments of the second phase of the algorithm, an objective is to output the best condensed set of thresholds which were crossed within the class model for a given EM prediction. This is done for each row in the matrix, i.e., for each data example, and is output as Human Readable Sentences. These statements are made in the form of “sentences” comprised of “words” where each word is an inequality represented by a subset of features. The number of sentences and words needed to describe the decision boundary in all its accuracy grows combinatorially with the number of features, and thus, for embodiments, using all of them would result in an impractically large number of sentences and thus complicated explanation of the classifiers decision. Thus, we trade-off accuracy to the full decision boundary by limiting potential explanations to a small number of sentences (input parameter) derived from a small number of words inequalities (input parameter) composed of the top k important features output by the previous algorithm phase. Each sentence s can be thought of as a polytope edge in the full feature space which defines the activation of the class label. This problem is both tractable and efficient, as embodiments first narrow the full dataset feature space down to a presumable small k top features for this meta-classifier to learn how to best describe a class with no more than s sentences.

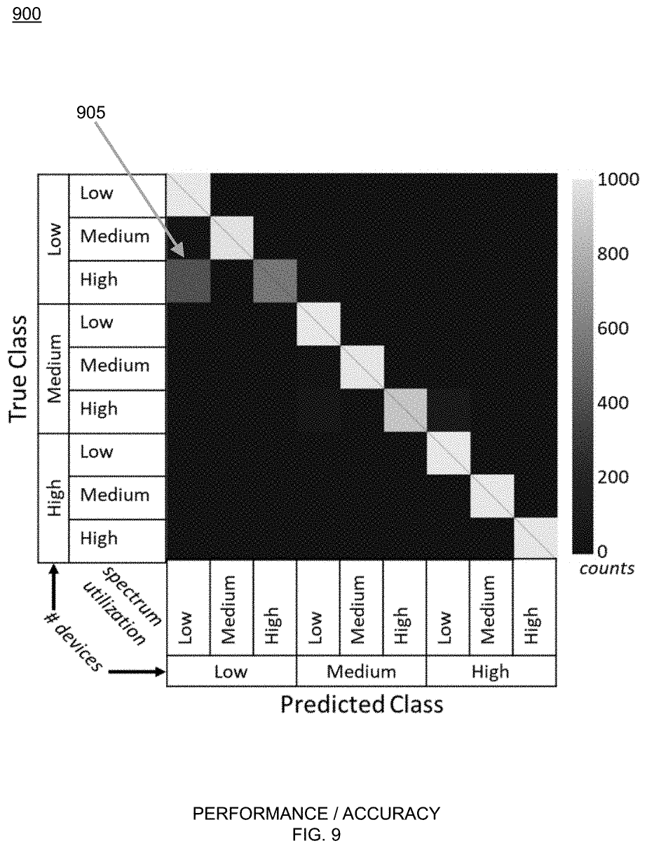

FIG. 9 depicts CM performance results 900 on the 9 classes for the spectrum monitoring dataset. As previously described, for each of three device number bins (high, medium, low), there are three spectrum utilization bins (high, medium, low). The CM performs quite well, achieving an average accuracy of 93%. Embodiments had issues with the low utilization and high device population case 905, as activity can look like far more devices are present when small populations of devices are performing a large, diverse set of tasks, and thus looks like a larger device set. Embodiments employed deeper CM architectural choices and temporal dilation rates ranging from 1-32 and found the best performance to be with minimal dilatation (1, 2) and only 4 Dilated Convolutional Layers. This is a more compact model than some other applications, such as RF fingerprinting, which required deeper architectures to learn discriminating features.

EM embodiment results and variance between ground truth and the CM labels are shown in Table 1. EM CLASSIFICATION

| Devices | Utilization | Acc. | | Prec. | | Rec. | | F1 | |
|---|---|---|---|---|---|---|---|---|---|
| Low | Low | .13 | .92 | .00 | .97 | .00 | .90 | .00 | .94 |
| | Medium | .53 | .93 | .49 | .97 | .95 | .91 | .65 | .94 |
| | High | .52 | .93 | .48 | .97 | .95 | .91 | .84 | .94 |
| Medium | Low | .75 | .93 | .74 | .97 | .96 | .92 | .84 | .94 |
| | Medium | .57 | .93 | .51 | .97 | .99 | .92 | .67 | .94 |
| | High | .75 | .93 | .74 | .97 | .96 | .91 | .84 | .94 |
| High | Low | .75 | .93 | .74 | .97 | .96 | .92 | .84 | .94 |
| | Medium | .86 | .93 | .87 | .97 | .97 | .91 | .92 | .94 |
| | High | .24 | .93 | .13 | .97 | 1.0 | .91 | .23 | .94 |

The ground truth accuracy shows there are a feasible amount of features to perform the classification task. EM performance on CM labels was significantly better than on ground truth labels. It is imperative to keep in mind that the goal of the EM is not to do well on ground truth outside of demonstrating reasonable class discrimination feasibility, the true goal being to mimic the decision boundaries of the CM. Thus, it is less surprising that EM embodiments struggled with a different class than the CM, but was able to pick up on the CM classifications for this weak class to a high degree of certainty. As an example, EM embodiments struggled with low utilization, low transmitter population on the ground truth dataset, but did very well in learning the decision plane of the CM on this class. This indicates the pre-classification step of the CM creates more separation in class hyperplanes on the raw spectrogram dataset. There are instances in EM inference, due to the one-versus-all model schema, where more than one class is activated. In these cases, the class with highest prediction probability was chosen as the class label.

Table 2 is a summary of EM results from parsing function and true labels. The first row of each cell is accuracy/precision/recall/F1 score. Rows two-four or each cell are the ordered top-three factors of importance in obtaining the result. The labels are: brightness_x: the total brightness in segment x; brightness_x_y: whether there is brightness crossing from segment x to segment y; count_x: the number of bright sections in segment x.

| | | Spectrum utilization | | |
|---|---|---|---|---|
| | | Low | Medium | High |
| Number | 2 | 0.13 0.00 0.00 0.00 | 0.53 0.49 0.95 0.65 | 0.52 0.48 0.95 0.84 |
| of | | brightness_1_2 | brightness_1_2 | brightness_1_2 |
| devices | | brightness_3 | brightness_3 | count_2 |
| | | count_2 | count_2 | brightness_4 |
| | 4 | 0.75 0.74 0.96 0.84 | 0.57 0.51 0.99 0.67 | 0.75 0.74 0.96 0.84 |
| | | brightness_1_2 | brightness_1_2 | brightness_3 |
| | | count_2 | brightness_3 | count_2 |
| | | brightness_4 | count_2 | brightness_4 |
| | 6 | 0.75 0.74 0.96 0.84 | 0.86 0.87 0.97 0.92 | 0.24 0.13 1.00 0.23 |
| | | brightness_1_2 | brightness_1_2 | brightness_1_2 |
| | | brightness_3 | brightness_3 | brightness_3 |
| | | count_2 | count_2 | count_2 |

Table 3 is a summary of EM results from parsing function and DCC-inferred labels. Same format as Table 2.

| | | Spectrum utilization | | |
|---|---|---|---|---|
| | | Low | Medium | High |
| Number | 2 | 0.92 0.97 0.90 0.94 | 0.93 0.97 0.91 0.94 | 0.93 0.97 0.91 0.94 |
| of | | brightness_5 | brightness_5 | brightness_5 |
| devices | | time_5 | brightness_3 | brightness_3 |
| | | time_8 | time_5 | time_5 |
| | 4 | 0.93 0.97 0.92 0.94 | 0.93 0.97 0.92 0.94 | 0.93 0.97 0.91 0.94 |
| | | brightness_5 | brightness_5 | brightness_5 |
| | | brightness_3 | brightness_1 | brightness_3 |
| | | brightness_1 | time_5 | ′time_5 |
| | 6 | 0.93 0.97 0.92 0.94 | 0.93 0.97 0.91 0.94 | 0.93 0.97 0.91 0.94 |
| | | brightness_5 | brightness_5 | brightness_5 |
| | | brightness_1 | brightness_1 | brightness_3 |
| | | time_5 | time_5 | time_5 |

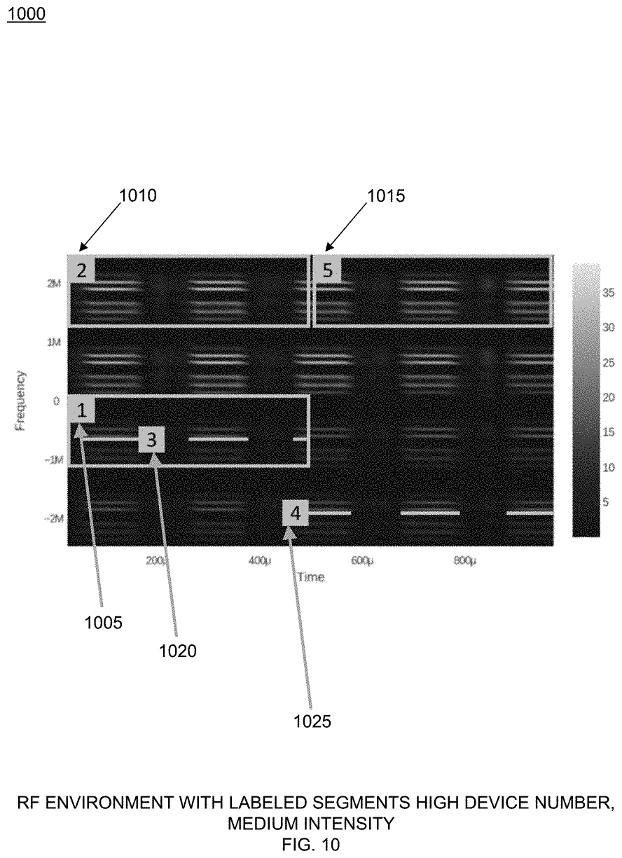

FIG. 10, depicts an RF environment with labeled segments for high device number and medium intensity 1000. It shows an example of the complexity involved in correctly estimating the RF scene by embodiments of the CM, where embodiments of the EM fail when decoupled from the CM, i.e., performing classification itself based on the full set of expert features. In this case, the true class output is high device count and medium amount of spectrum access. As can be seen in the Figure, the EM has learned to key on using three channelized segments, shown by the rectangular outline overlays for the EM's selected features 1 (1005), 2 (1010), & 5 (1015), and two time segments, overlays 3 (1020) & 4 (1025), to describe this class. In embodiments, these expert features are not enough on their own, however, to fully describe the class and separate it from other classes. The CM in this case does correctly classify the class, however lacks the insight and understandability into the important features. Coupling the two approaches together provides the power of the CM to get high performance accuracy, while simultaneously allowing the EM to describe the important features given the RCM learned decision plane. This case illustrates where more solely feature based approaches fail when there is ambiguity.

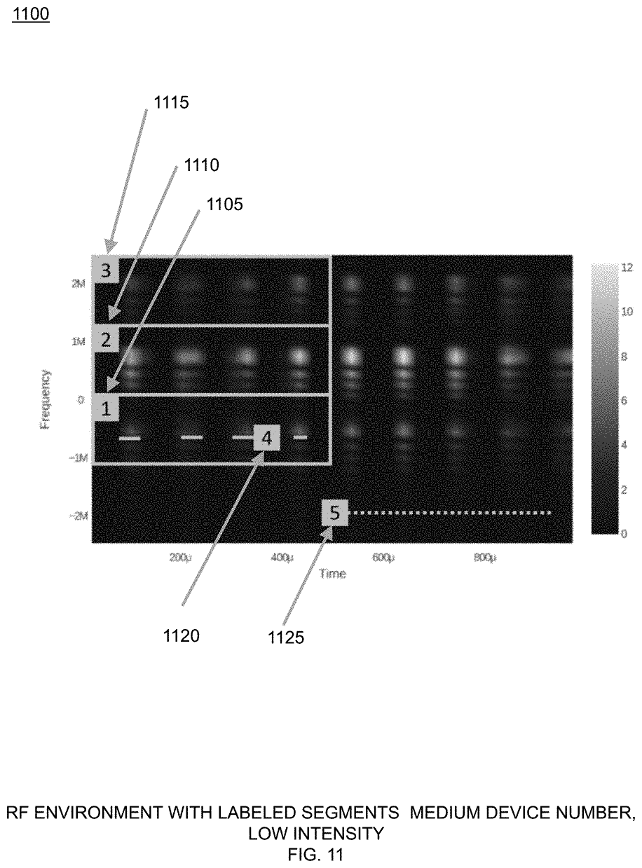

FIG. 11 depicts an RF environment with labeled segments for medium device number and low intensity 1100. It shows both models correctly classifying an example. In this case, the EM has learned that the 3 channelized segments (1 (1105), 2 (1110), 3 (1115)) and two time segments (4 (1120), 5 (1125)) are important and the set of expert features are enough to classify. These two cases are shown to highlight how scenes are traditionally thought about, as those that can be easily separated by expert defined spaces, and those with a heavy amount of underlying class ambiguity.

These samples are not to showcase deep learning (CM) over decision trees (EM) for classification, but to highlight the explainable set of features that are tagged with the examples, i.e. the annotated overlays. The EM is able to extract a small set of relevant features that explain the predicted class of the scene, and can enable an operator to be focused in on certain areas for further analysis. The example scenes are rather simple in order to prove out this XAI approach, but in other embodiment applications they grow to help address complex scenes in today's world of rapidly growing number of devices and density of different spectrum access technologies. An operator could use these call outs to identify trust or lack thereof in an AI application.

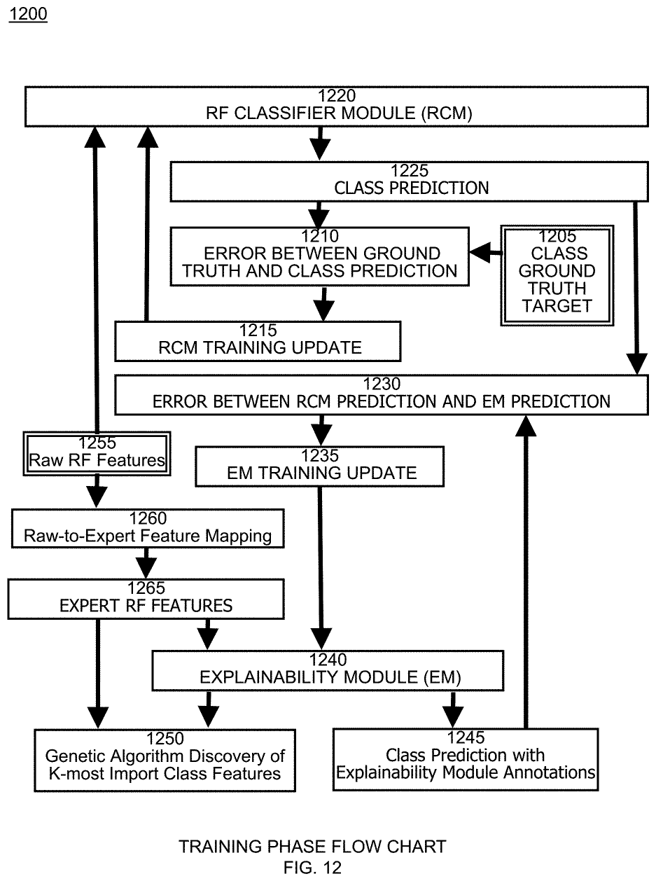

FIG. 12 depicts a Training Phase method flowchart 1200. In the Training Phase, the system is trained to perform explainable classification. Steps comprise training input of Class Ground Truth Target 1205 which provides input to Error Between Ground Truth and Class Prediction Module 1210. Output of Error Between Ground Truth And Class Prediction Module provides input to RCM Training Update Module 1215. RCM Training Update Module output provides input to RF Classifier Module (RCM) 1220. Output of RCM provides input to Class Prediction Module 1225. Output of Class Prediction Module provides a first input to Error Between RCM Prediction and Explainability Module (EM) Prediction Module 1230. Output of Error Between RCM Prediction and EM Prediction Module provides input to EM Training Update Module 1235. Output of EM Training Update Module provides input to Explainability Module (EM) 1240. Output of EM provides input to Class Prediction with Explainability EM Annotations module 1245 and a first input to Genetic Algorithm Discovery of K-most Important Class Features Module 1250. Output from Class Prediction with Explainability EM Annotations module provides a second input to Error Between RCM Prediction and EM Prediction Module 1230. A second input to Training Phase 1200 is Raw RF Features 1255. Output of Raw RF Features provides input to both RCM 1220 and Raw-to-Expert Feature Mapping Module 1260. Output of the Raw-to-Expert Feature Mapping Module provides input to Expert RF Features 1265. Output of Expert RF Features provides a second input to EM 1240 and a second input to Genetic Algorithm Discovery of K-most Important Class Features Module 1250.

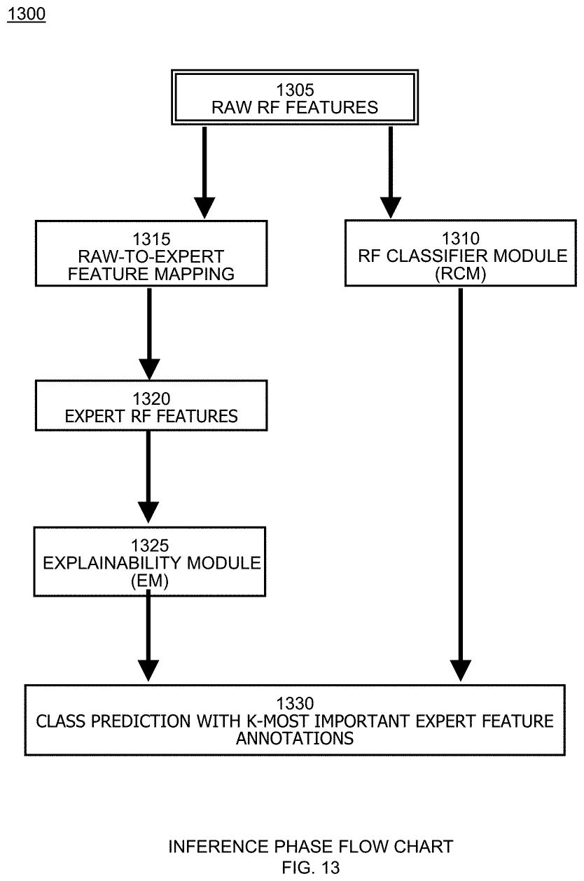

FIG. 13 depicts an Inference Phase method flowchart 1300. In the Inference Phase, the system has been trained already, and is being queried for class predictions with expert annotations provided by the explainability module. Steps comprise input of Raw RF Features 1305 to both (trained) RCM 1310 and (trained) Raw-to-Expert Feature Mapping 1315. Output of Raw-to-Expert Feature Mapping provides input to (trained) Expert RF Features 1320. Output of Expert RF Features provides input to (trained) Explainability Module (EM) 1325. Finally, output of both RCM and EM provide input to Class Prediction with K-most Important Expert Feature Annotations 1330, which is the output of the system.

Embodiments the ability to classify with high accuracy the RF scene decision space and the EM to explain its predictions for the spectrum monitoring task. Since the EM tries to attribute CM predictions using a feature set derived from the actual dataset used to train the CM, there is a possibility embodiments' explanations may lack sensitivity. Other deep learning explainability methods which rely on estimating or computing gradients, or Integrated Gradients have high sensitivity to changes in predicted label but are limited to using the neural network's raw input features to construct explanations. For domains where this data is familiar to human sensory modalities such images or text, this is not much of a problem, but in domains where the neural network input data itself is not intuitive to humans it becomes very limiting since important raw features are confusing themselves. Thus there is a need to be able to correlate expert derived features to construct meaningful explanations. By this, some sensitivity is sacrificed to gain back utility. The classification accuracy of the EM on the CM labels provides a soft measure of its sensitivity. Further EM sensitivity can be increased by using finer grained expert features. In other work, expert feature generation was an iterative process to tune to operator tastes.

Additionally there is a question of: is it desired there is a question of: is it desired to have a small set of important features which uniquely determine the class label or is having a unique feature set for each class desired. There is merit to both situations. In the former, an operator might only require verifying small k features to assess correctness. With k features being set low, this may also result in many state transitions being explained similarly. This is desirable as the operator will inherently know where to look to find trust in the AI performance. On the other hand, it may not provide the operator enough separation of states, thus diverging to checking all possible classes. In this case, having a unique or near unique set of important features per class is desirable for the operator to trust the classifier since there is specific evidence for a certain class and varying evidence toward other classes. This leads to the trade-off between complexity and ease of determination. For example, suppose an operator has 30 features, to describe why a complex and potentially crucial decision was made. This may not capture the human intuition for a human operator to make a competing decision. However, the contrary comes at the expense of complexity and speed of decision time. As the number of expert features grows, the difficulty in memorizing or referencing such a catalog of features may overbear the ease of explanation. Explainability in AI remains a trade-off between complexity of problem solving and explainability of solution mechanics.

Embodiments have shown a satisfactory middle ground for this defined problem, embodiments relegate the size of the SME dictionary and component features therein to a specific application.

The computing system used for the radio frequency environment awareness with explainable results system for performing (or controlling) the operations or functions described hereinabove with respect to the system and/or the method may include a processor, FPGA, I/O devices, a memory system, and a network adaptor. The computing system includes a program module (not shown) for performing (or controlling) the operations or functions described hereinabove with respect to the system and/or the method according to exemplary embodiments. For example, the program module may include routines, programs, objects, components, logic, data structures, or the like, for performing particular tasks or implement particular abstract data types. The processor may execute instructions written in the program module to perform (or control) the operations or functions described hereinabove with respect to the system and/or the method. The program module may be programmed into the integrated circuits of the processor. In an exemplary embodiment, the program module may be stored in the memory system or in a remote computer system storage media.

The computing system may include a variety of computing system readable media. Such media may be any available media that is accessible by the computer system, and it may include both volatile and non-volatile media, removable and non-removable media.

The memory system can include computer system readable media in the form of volatile memory, such as random access memory (RAM) and/or cache memory or others. The computer system may further include other removable/non-removable, volatile/non-volatile computer system storage media. The computer system can communicate with one or more devices using the network adapter. The network adapter may support wired communications based on Internet, LAN, WAN, or the like, or wireless communications based on CDMA, GSM, wideband CDMA, CDMA-2000, TDMA, LTE, wireless LAN, Bluetooth, or the like.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++ or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to a flowchart illustration and/or block diagram of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing description of the embodiments has been presented for the purposes of illustration and description. It is not intended to be exhaustive or to limit the invention to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure. Other and various embodiments will be readily apparent to those skilled in the art, from this description, figures, and the claims that follow. It is intended that the scope of the invention be limited not by this detailed description, but rather by the claims appended hereto.

What is claimed is:

1. A Deep-Learning (DL) explainable AI system for Radio Frequency (RF) machine learning applications with expert driven neural explainability of input signals comprising:
a Classifier Module;
an Explainability Module;
an Important Features module;
a Training Phase; and
an Inference Phase;
said Training Phase comprising a first training input comprising a Ground Truth Training Input and a second training input comprising a Raw RF Features Training Input;
said Inference Phase comprising input of Raw RF Features input signals; and
an output of Ground Truth comprising Feature Annotation, whereby said explainability is provided.

2. The system of claim 1, wherein said Training Phase comprises:
an Error Between Ground Truth and Class Prediction Module receiving said first training input of a Class Ground Truth Target;
an RF Classifier Module (RCM) RCM Training Update Module receiving input from said Error Between Ground Truth and Class Prediction Module;
an RF Classifier Module (RCM) receiving input from said RCM Training Update Module;
a Class Prediction Module receiving input from said RCM;
an Error Between RCM Prediction and Explainability Module (EM) Prediction Module receiving a first input, from said Class Prediction Module;
an EM Training Update Module receiving input from said Error Between RCM Prediction and EM Prediction Module;
an Explainability Module (EM) receiving input from said EM Training Update Module;
a Class Prediction with EM Annotations Module receiving input from said EM, said Class Prediction with EM Annotations Module providing a second input to said Error Between RCM Prediction and EM Prediction Module;
a Genetic Algorithm Discovery of K-most Important Class Features Module also receiving input from said EM;
said second training input Raw RF Features Training Input providing input to said RCM;
a Raw-to-Expert Feature Mapping Module also receiving input from said Raw RF Features training input;
an Expert RF Features Module receiving input from said Raw-to-Expert Feature Mapping Module, and providing a second input to said EM; and
a Genetic Algorithm Discovery of K-most Important Class Features Module receiving an input from said Expert RF Features Module, and receiving a second input from said EM, thereby producing a trained system.

3. The system of claim 1, wherein said Inference Phase comprises:
a trained Classifier Module receiving said Raw RF Features input signals;
a Raw-to-Expert Feature Mapping Module also receiving said Raw RF Features input signals;
an Expert RF Features Module receiving input from said Raw-to-Expert Feature Mapping Module;
a trained Explainability Module receiving input from said Expert RF Features Module; and
outputting a Class Prediction with K-most Important Expert Feature Annotations for said Raw RF Features input signals, whereby said input signal classification with explainability is provided.

4. The system of claim 1, wherein said Radio Frequency (RF) machine learning applications comprise scene context change detection and classification; and
input signals are digital Radio Frequency (RF) Wi-Fi 802.11a/g waveforms.

5. The system of claim 1, wherein classes comprise two primary traffic parameters, a number of devices in a scene and their spectrum usage or spectral density.

6. The system of claim 1, wherein a number of devices comprise 3 sub-classes, low, medium, and high.

7. The system of claim 1, wherein spectral density comprises 3 sub-classes, low, medium, and high.

8. The system of claim 1, wherein expert feature generation provides a set of human interpretable features that an expert who is monitoring the spectrum would understand and use to describe the scene.

9. The system of claim 1, wherein expert features comprise time, frequency, and power.

10. The system of claim 1, wherein an EM feature vector comprises:
a Brightness of received power normalized between 0 and 1;
a Time-half determining an amount of activity in early and later parts of a monitored period, enumerated as 1 or 2;
an Energy in segment as a sum of all values in segment x, min-maxed normalized;
a Time-energy product in segment x count of time bins in segment x for which any pixels exceed half a max value in said segment x; and
a Consistent energy from segment x to y Boolean, set to true if both halves of a time period have relatively equal amounts of energy.

11. The system of claim 10, wherein said Brightness, said Segment energy, and said Time-energy product each comprises 8 features, 1 for each segment, said Consistent energy produces 4 features for channelized transients between time segments, and said Time-half produces 2 features, one for each half, wherein all features are encoded into said feature vector, of size 30.

12. The system of claim 1, comprising two correlated datasets, one of raw spectrograms for classification by said deep learning-based CM, and a second which is a simplified human annotated dictionary for classification by said EM.

13. The system of claim 1, wherein said DCC comprises a 3-dimensional DCC operator whereby a tight coupling of phase and magnitude is maintained throughout feature extraction of a network.

14. The system of claim 1, wherein said EM comprises a down-selection of features most relevant for each classification label, wherein classes are processed one class at a time in a one-versus-all fashion.

15. The system of claim 1, wherein each sentence s can be thought of as a polytope edge in a full feature space which defines an activation of a class label.

16. A non-transient computer readable medium containing program instructions for causing a computer to perform the method of:
inputting a first training input comprising a Ground Truth Training Input in a Training Phase; and
inputting a second training input comprising a Raw RF Features Training Input in said Training Phase;
training a Classifier Module in said Training Phase;
training an Explainability Module in said Training Phase;
training an Important Features module in said Training Phase;
inputting Raw RF Features input signals in an Inference Phase; and
outputting Ground Truth comprising Feature Annotation, whereby explainability is provided.

17. The method of claim 16, wherein input comprises a spectrogram for each sample scene class being 5 MHz wide and 1 ms in duration.

18. The method of claim 16, wherein input comprises a spectrogram for each sample scene class with bin spacing forming a 128×38×2 sized image comprising phase and magnitude, where nfft=128, noverlap=128, and window=256.

19. The method of claim 16, wherein input comprises spectrograms comprising two channels in a third dimension where phase and magnitude representation maintain a complex-valued nature of underlying data, and a training dataset is constructed with 1,000 examples per class.

20. A Deep-Learning (DL) explainable AI method for scene context change detection and classification with expert driven neural explainability of input signals comprising:
a Training Phase; and
an Inference Phase;
said Training Phase comprising:
an Error Between Ground Truth and Class Prediction Module receiving said first training input of a Class Ground Truth Target;
an RCM Training Update Module receiving input from said Error Between Ground Truth and Class Prediction Module;
an RF Classifier Module (RCM) receiving input from said RCM Training Update Module;
a Class Prediction Module receiving input from said RCM;
an Error Between RCM Prediction and Explainability Module (EM) Prediction Module receiving a first input, from said Class Prediction Module;
an EM Training Update Module receiving input from said Error Between RCM Prediction and EM Prediction Module;
an Explainability Module (EM) receiving input from said EM Training Update Module;
a Class Prediction with EM Annotations Module receiving input from said EM, said Class Prediction with EM Annotations Module providing a second input to said Error Between RCM Prediction and EM Prediction Module;
a Genetic Algorithm Discovery of K-most Important Class Features Module also receiving input from said EM;
said second training input Raw RF Features Training Input providing input to said RCM;
a Raw-to-Expert Feature Mapping Module also receiving input from said Raw RF Features training input;
an Expert RF Features Module receiving input from said Raw-to-Expert Feature Mapping Module, and providing a second input to said EM; and
a Genetic Algorithm Discovery of K-most Important Class Features Module receiving an input from said Expert RF Features Module, and receiving a second input from said EM, thereby producing a trained system;
wherein said Inference Phase comprises:
a trained RF Classifier Module receiving said Raw RF Features input signals;
a trained Raw-to-Expert Feature Mapping Module also receiving said Raw RF Features input signals;
a trained Expert RF Features Module receiving input from said Raw-to-Expert Feature Mapping Module;
a trained Explainability Module receiving input from said Expert RF Features Module; and
outputting a Class Prediction with K-most Important Expert Feature Annotations for said Raw RF Features input signals, whereby said input signal classification with explainability is provided.
